(19) United States
(12) Patent Application Publication
(10) Pub. No.: US 2008/0300515 A1
(43) Pub. Date: Dec. 4, 2008

(54) Focused Chest Compression System and Method of Using Same

(76) Inventors: Mario Nozzarella, Coon Rapids, MN (US); Leland G. Hansen, St. Paul, MN (US)

Correspondence Address: FULBRIGHT & JAWORSKI L.L.P., 80 SOUTH EIGHTH STREET, SUITE 2100, MINNEAPOLIS, MN, 55402, US

(21) Appl. No.: 11/966,967

(22) Filed: Dec. 28, 2007

Related U.S. Application Data
(60) Provisional application No. 60/877,491, filed on Dec. 28, 2006.

(51) Int. Cl. A61H 31/00

(52) U.S. Cl. 601/41

(57) ABSTRACT

A system and method are described which permits the directed application of a percussive force to the chest wall to loosen mucus. Airway clearance therapy can be provided by repeated application of air impulses transmitted through the device. The device receives air from an air compressor or pulsating therapy unit (PTU), and forces the air into a flexible membrane inside a cup-like cavity. The open side of the cup is where the membrane expands outwardly into contact the patient's chest when it receives pressure pulses. Rapidly repeated air impulses impact the chest to dislodge mucus adherent to airways within in the lungs. Strategic placement of the device permits focused treatment of affected lung regions. Administration of air impulses to the chest wall is continued until treatment is completed. A pressure sensor can be provided to ensure that the device is properly placed on the patient's body.

### RELATED APPLICATIONS

This application claims priority under 35 U.S.C. 119(e) from provisional U.S. Patent Application No. 60/877,491, filed Dec. 28, 2006, the contents of which are incorporated herein by reference.

### FIELD OF THE INVENTION

The present invention relates generally to a pneumatic force delivery system and more particularly to a system for providing periodic percussions to a chest of a patient.

### BACKGROUND OF THE INVENTION

Cystic fibrosis (CF) is the most common life-shortening inherited disease in the United States. Pathology arises from mutations in the gene coding for the cystic fibrosis transmembrane conductance regulator (CFTR). CF occurs most frequently in Caucasians, but increasingly is being diagnosed in individuals of Hispanic, African-American and Asian heritage respectively.

CF is a systemic condition that affects all mucus-producing organ systems, including the intestines, pancreas and lungs. However, lung disease accounts for the majority of morbidity and mortality in CF. In CF airways, metabolic abnormalities result in production of large quantities of abnormally viscous mucus. As mucus production exceeds the ability of the body's natural mechanisms for efficient clearance, a vicious cycle of pulmonary decline is set in motion; mucus continues to accumulate, bacteria are nourished and multiply, infection is established, inflammation intensifies, more mucus is produced and mucus plugs obstruct airways. Recurrent infections accelerate the cycle. Failure to remove excess and/or infectious secretions from the lungs leads to advanced lung disease (bronchiectasis), respiratory failure and, ultimately, death.

CF is an expensive disease. Cost-intensive treatments, in addition to frequent clinic visits and hospitalizations, include oral and intravenous antibiotics, aerosolized medications such as recombinant human DNase, bronchodilators, hyptertonic saline and professionally administered chest physiotherapy (CPT). Individual lifetime care costs vary greatly; according to a recent estimate, average direct costs exceed $400,000. Expenditures for patients with uncontrolled, progressive disease greatly exceed that figure. Healthcare costs for CF patients with good disease management are substantially below average. To reduce the risk for CF-related pulmonary complications, all patients require daily airway clearance therapy (ACT) throughout life regardless of disease severity. The benefits of ACT are significantly better if treatment begins before the development of significant lung disease. Most children with CF are now diagnosed in the first 2 months of life. Because inflammation is present and airway secretions are abnormal soon after birth, therapy to remove excess airway mucus is recommended at diagnosis even for asymptomatic infants. The mean age at institution of ACT is about 2.1 months.

A variety of ACT techniques are available, but all except chest physiotherapy (CPT) and high frequency chest percussion (HFCC) require physical coordination and/or cognitive skills. For several reasons, CPT is currently the only method widely used for infants. CPT is a therapeutic technique that combines manual percussion of the chest wall to loosen secretions and strategic positioning of the patient, utilizing gravity, to promote mucus drainage. Typically, a treatment session consists of manual percussion for 3-5 minutes on each of 9-12 specific thoracic regions while assuming appropriate drainage postures. Although CPT is an effective method for mobilizing mucus, its benefits are compromised by a number of factors; CPT is technique-dependent, labor-intensive, time-consuming and can be costly. Patients must be able to cooperate with and tolerate percussion and positioning. For some individuals, including infants, CPT may be positively harmful. Standard procedure requires downward positioning of patients' head and lungs below the lower esophageal sphincter (Trendelenburg position), sometimes permitting stomach contents to flow back into the mouth (reflux) and be inhaled (aspiration). Refluxed gastric contents associated with CPT have been shown to cause upper respiratory symptoms, accelerated lung deterioration and other complications.

High frequency chest compression (HFCC) is an alternative to CPT. HFCC meets or exceeds all therapeutic performance requirements but has none of the associated disadvantages; it requires no special technical skills or physical abilities, is not position-dependent and treats all lobes of the lung simultaneously. For most patients, minimal or no caregiver assistance is required. The in Courage™ HFCC System (RespirTech, St. Paul, Minn.) is a commercially available HFCC machine. The in Courage™ HFCC System consists of an inflatable jacket-like garment fitted to the torso and attached by lengths of tubing to a machine that generates air pressure pulses (pulsating therapy unit [PTU]). Compressive forces are delivered to the chest wall via the jacket to produce secretion-clearing oscillatory air flow effects within the lungs.

Currently, HFCC is the most widely used ACT for American CF patients over 2 years of age. However, the technology is not yet sufficiently developed for use in infants and very small children. Vest/jacket garments engineered to accommodate the small circumference of infant chests are not yet available. Moreover, there is concern that, because of the increased compliance of infant chest walls, whole chest compression may pose unknown risks. Thus, CPT, with all its limitations, has been the only option for premature babies, newborns, infants and very tiny toddlers.

HFCC has an additional disadvantage for adult CF patients who frequently recognize when specific lung regions are particularly congested or infected. Because HFCC pressures are distributed uniformly by the vest/jacket to all segments of the lung, they may not strategically treat problem areas.

### SUMMARY OF THE INVENTION

The present invention is intended to function as a system and method that permits the directed application of a compressive force to the chest to loosen mucus. The device receives air from an air compressor or pulsating therapy unit (PTU), and forces the air into a flexible membrane inside a cup-like cavity. The membrane expands to contact the patient's chest in response to delivered air pulses. Rapidly repeated air impulses impact the chest to dislodge mucus adherent to airways within in the lungs. Strategic placement of the device permits focused treatment of affected lung regions. The pulsations created by the expansion of the membrane are continued until such time as treatment is completed. A pressure sensor is provided to ensure that the device is properly placed on the patient's body.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying FIGURES. It is to be expressly understood, however, that each of the FIGURES is provided for the purpose of illustration and description only and is not intended as a definition of the limits of the present invention.

### BRIEF DESCRIPTION OF THE DRAWINGS

FIG. 1 is a perspective view of a chest percussor system according to one embodiment of the present invention.

FIG. 2 is a bottom view of a chest percussor device of FIG. 1.

FIG. 3 is a side elevational view of the chest percussor device of FIG. 1.

FIG. 4 is a cross-sectional view of the chest percussor device of FIG. 1 taken along lines 4-4 of FIG. 2.

FIG. 5 is another depiction of a chest percussor system.

### DETAILED DESCRIPTION OF THE INVENTION

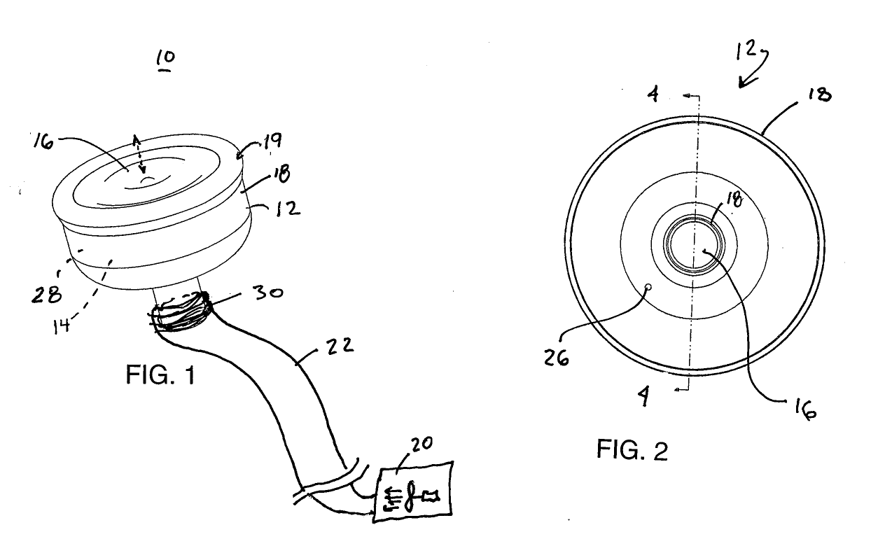

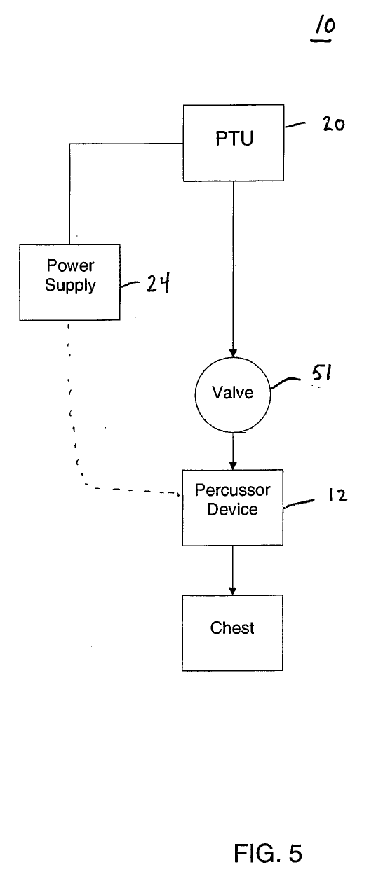

FIG. 1 is a perspective view of chest percussor system 10 according to one embodiment of the present invention. FIG. 5 is a depiction of chest percussor system 10 in a flow diagram format. Chest percussor system 10 includes chest percussor device 12, control board 14, flexible percussion membrane 16, rigid shell 18 and fitting ring 19. Device 12 is connected to pulsating therapy unit (PTU) 20 providing periodic air pulses via hose 22.

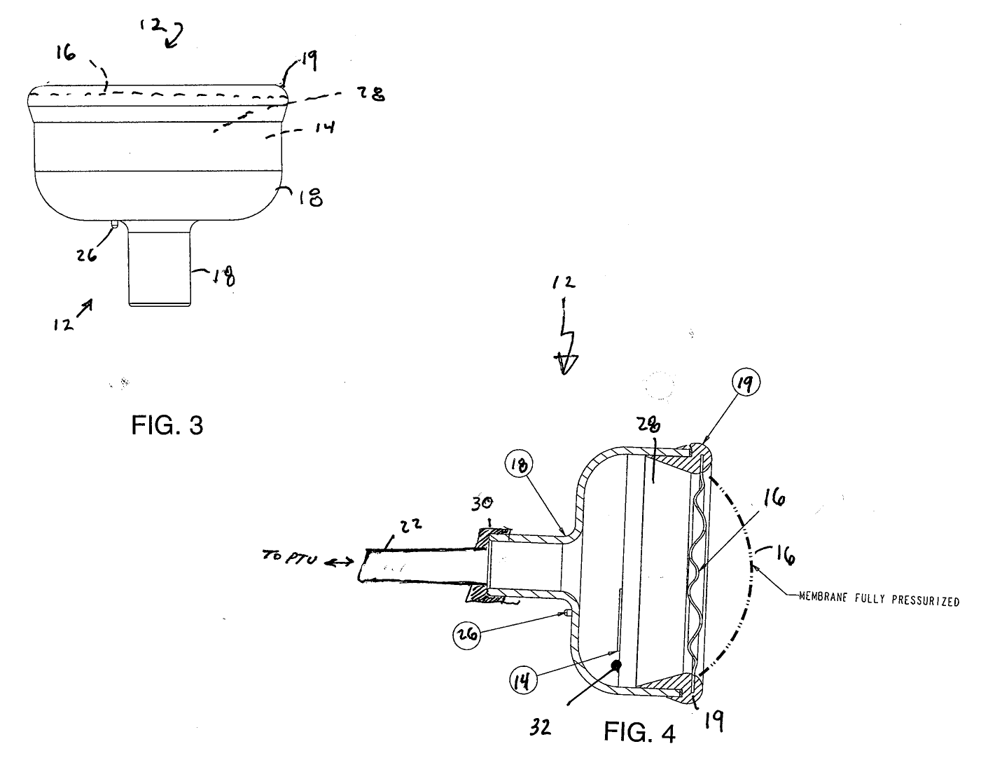

FIG. 2 is a bottom view of chest percussor device 12 of FIG. 1. FIG. 3 is a side elevational view of chest percussor device 12. FIG. 4 is a cross-sectional view, taken along lines 4-4 of FIG. 2, of chest percussor device 12.

Control board 14, which is shown in FIG. 4, is in one embodiment a circuit board which holds an electronic control unit that controls and/or facilitates proper use of the operation of chest percussor system 10. Control board 14 is connected to power supply 24, which is depicted in FIG. 5. Power supply 24 can be a battery, an AC power source, or any other type of power supply. Further the power supply can be located elsewhere on device 12 or on PTU 20. In another embodiment, control board 14 may be remotely positioned relative to percussor device 12.

In one embodiment, control board 14 prevents operation of system 10 until a predetermined situation is met. For example, control board 14 can prevent the actuation of the percussor device 12 if a proper fit is not achieved or system 10 has been used too recently. However, other control parameters can be used.

In one embodiment, when system 10 is ready to be used, control board 14 can transmit a signal to light 26 to indicate percussor device 12 is ready to use. Light 26 is shown in FIGS. 2-4. Light 26 is, in one embodiment, a simple light emitting diode (LED). In some embodiments control board 14 also turns system 10 on or off so that it can be used by the patient or caregiver. In other embodiments a control board communicates with a remote air pump to cause an impulse air charge to be transmitted to the device. In yet another embodiment a control board opens a valve (illustrated in FIG. 5 as element 51) that allows air in hose 22, which is shown in FIGS. 1 and 4, to react against flexible membrane 16.

Rigid shell 18 forms a portion of chamber or cavity 28. Rigid shell 18 allows air pressure provided from PTU 20 to be directed towards flexible membrane 16. Rigid shell 18 can be made of any rigid material, such as metal or plastic. However, other materials can be used. Incorporated into a portion of rigid shell 18 is a connection component 30, which is shown in FIGS. 1 and 4. Connection component 30 provides a fluid connection with PTU 20 via air hose 22. Connection component 30 can be a pressure fitting, a snap fitting, a screw fitting or any other attachment mechanism.

Fitting ring 19 is a seal that allows device 12 to be properly fit on the skin of the patient. Proper fitting of percussor device 12 to the chest of the patient is necessary to ensure that the compressive force is correctly oriented relative to the patient's chest. Fitting ring 19 can be made from a semi flexible material such as a gel-filled plastic. However, other materials can be used. By using a semi flexible material a more comfortable fitting on the patient is possible.

Pressure sensor 32, which is shown in FIG. 4, provides pressure information to control board 14. In another embodiment, multiple pressure sensors 32 could be used. Pressure sensor 32 can assume different formats or configurations. In one embodiment, pressure sensor 32 is configured to provide a signal to control board 14 when a certain pressure level is reached. However, in other embodiments pressure sensor 32 can provide a signal that a certain air pressure has been exceeded. This exceeded pressure could indicate that the caregiver or patient is pressing the device too hard and activation of the device could cause injury.

Percussion membrane 16 is provided inside the circumference of fitting ring 19. Percussion membrane 16 responds to applied air pressure by expanding outwardly towards the patient. Percussion membrane 16 is made from a flexible material. For example the percussion membrane 16 can be made from nylon, fabric, rubber, plastic, metal or any other material that will bend in response to the applied air pressure. In one embodiment membrane 16 has a series of ridges in it. However, the ridges need not be present. When air pressure is applied during system 10 operation, membrane 16 periodically expands and moves into engagement with the patient's chest. An expanded depiction of membrane 16 is illustrated in phantom in FIG. 4.

Percussor system 10 of the present invention can be used in at least two distinct situations. The first situation is on an infant or small child, and the second is on an adult patient. For reasons described above vest/jacket—based compressions systems are unsuitable for infants or very small children. Currently, no manufacturer provides a compression vest/jacket for a child under the age of 18 months. Part of the problem in making vests so small is that the amount of air that is used to fill a vest/jacket of this size can cause other problems to the child. This leaves parents and caregivers with no alternative but to manually percuss the child's chest. Adult sufferers of CF often know exactly where in their lungs additional therapy may be needed. However, the problem with using a vest/jacket is that percussive forces are not focused on specific lung regions; instead, pressures are distributed uniformly by the vest/jacket to all segments of the lung, thus precluding strategic treatment to problem areas.

In one embodiment the caregiver places the percussor device 12 on the chest of the child. A force is applied to percussor device 12 causing fitting ring 19 to form a seal upon the chest of the child. As fitting ring 19 is pressed into place pressure sensor 32 reacts to the pressure and communicates this pressure to control board 14. When control board 14 determines that the pressure is sufficient to allow the compression to occur, light 26 is illuminated. In some embodiments the illumination of light 26 may also be a warning indication that air pressure is about to be automatically released. In other embodiments the user would engage a switch on PTU 20 or the device 12 to allow the air to charge the device 12.

Once the system 10 is ready, the air is provided from the PTU 20. This air flows through hose 22 and into cavity 28, which is shown in FIG. 4. The rigid portion of the device 12 limits deflection or expansion from occurring away from the membrane. As the air pressure builds up in cavity 28, the membrane 16 expands along the predetermined direction towards the area of maximum expansion. However, as membrane 16 contacts the chest the expansion of the membrane 16 applies pressure to the chest, which in turn applies pressure to the lungs. The rate at which membrane 16 expands determines the force applied to the chest and hence the amount of pressure that reaches the lungs. In one embodiment the system provides periodic air pulses between 6 and 15 times per second. However, other rates can be used.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A chest percussor system comprising:
a control board;
a shell forming a portion of an air cavity;
a flexible membrane coupled to the shell forming a second portion of the air cavity;
an air inlet configured to provide an impulsive air charge to the cavity, the air charge causing the flexible membrane to expand outward; and
a pressure sensor coupled to a portion of the shell configured to detect when the device is in contact with a chest cavity.

2. A chest percussor device comprising:
a shell forming a portion of a air cavity;
a flexible membrane coupled to the shell and forming a second portion of the air cavity; and
an air inlet configured to receive an impulse air charge into the cavity, the impulse air causing the flexible membrane to expand outwardly.
